(19) United States
(12) Patent Application Publication
(10) Pub. No.: US 2026/0346341 A1
(43) Pub. Date: Nov. 5, 2026

(54) DRILL CHUCK AND DRILL

(71) Applicant: Roehm GmbH, Sontheim/Brenz (DE)

(72) Inventors: Peter SCHENK, Niederstotzingen (DE); Fabian MAYERLE, Blindheim (DE); Helmut ROTHENBERGER, Sontheim (DE)

(73) Assignee: Roehm GmbH, Sontheim/Brenz (DE)

(21) Appl. No.: 19/712,957

(22) Filed: Jun. 18, 2026

Related U.S. Application Data
(63) Continuation of application No. PCT/EP2024/083380, filed on Nov. 25, 2024.

(30) Foreign Application Priority Data
Dec. 19, 2023 (DE) 10 2023 135 846.4

(51) Int. Cl. B23B 31/12

(52) U.S. Cl. CPC B23B 31/1215; B23B 2231/34

(57) ABSTRACT

A drill chuck with a chuck body, the rear end of which has a spindle holder and the axially front end of which has a tool holder into which clamping jaws, which are displaceably guided in guide channels in the chuck body, extend. An annular collar having a non-circular first outer circumference protrudes axially rearwardly from the axially rear end of the chuck body. A drive bush, having a first inner circumference that is adapted to the first outer circumference for torque transmission, is present which is mountable on the annular collar. The axial extension of the drive bush is greater than that of the annular collar. The invention further relates to a drill.

This nonprovisional application is a continuation of International Application No. PCT/EP 2024/083380, which was filed on Nov. 25, 2024, and which claims priority to German Patent Application No. 10 2023 135 846.4, which was filed in Germany on Dec. 19, 2023, and which are both herein incorporated by reference.

### BACKGROUND OF THE INVENTION

### Field of the Invention

The invention relates to a drill chuck with a chuck body having a spindle holder at its rear end, and a tool holder at its axially front end into which clamping jaws, which are displaceably guided in guide channels in the chuck body, extend, wherein an annular collar having a non-circular first outer circumference protrudes axially rearwardly from the axially rear end of the chuck body, wherein a drive bush, having a first inner circumference that is adapted to the first outer circumference for torque transmission, is present which is mountable on the annular collar, and wherein the axial extension of the drive bush is greater than that of the annular collar. The invention further relates to a drill.

### Description of the Background Art

A drill chuck is known from EP 0 710 518 A2, which corresponds to U.S. Pat. No. 5,765,839, which is incorporated herein by reference, wherein for the basic design and functioning of the drill chuck, reference may be made to this document, which reflects the knowledge of the average person skilled in the art. DE 20 2013 101 255 U1, which corresponds to US 2014/0284888, which is incorporated by reference, and which discloses a drill chuck with a chuck body, at the rear end of which a spindle holder is provided for coupling to the drill spindle of a drill, the spindle holder having an internal thread into which the drill spindle with an external thread can be screwed. The axial securing of the drill chuck with respect to the drill spindle is provided by a passage formed in the chuck body through which a locking screw can be screwed into a screw receptacle of the drill spindle.

Modern drills are becoming increasingly powerful and can generate high torques of greater than 200 Nm, which must be transmitted safely to the drill chuck without overloading the connection between the chuck body and the drill spindle or jeopardizing subsequent detachability, thus also enabling a drill chuck change. In particular, it must be ensured that the drill spindle does not break, as this could endanger the user if the drill chuck separates from the drill during operation. Increasing the material thickness is not an easy solution, as the outer diameter of the drill chuck should not exceed 43 mm, since this value is accepted in the industry and the dimensions are adjusted accordingly.

### SUMMARY OF THE INVENTION

It is therefore an object of the present invention to provide a drill chuck that is capable of transmitting high torque and at the same time allows the user to change the drill chuck from a drill spindle without having to visit a service center. A further object is to provide a drill that is suitable for driving the drill chuck.

The drill chuck enables improved power transmission from the drill spindle of a drill, since instead of the widely used screw connection between the spindle and the drill chuck, which is responsible for the power transmission, an annular collar having a non-circular first outer circumference now protrudes axially rearwardly from the axially rearward end of the chuck body, wherein a drive bush, having a first inner circumference that is adapted to the first outer circumference for torque transmission, is present which is mountable on the annular collar, and wherein the axial extension of the drive bush is greater than that of the annular collar. The interaction of the annular collar and the drive bush is utilized to transmit the torque, meaning that the drive is independent of axial securing of the spindle, and thus the axial securing is also not affected by the acting torque. The invention allows for easy manufacture of the spindle and the chuck body.

To increase the material thickness of the drive bush, in a second outer circumference of the drive bush it is possible to provide channels for guiding the clamping jaws through, the number of channels at least corresponding to the number of clamping jaws; thus, the guidance of the clamping jaws and their position need not be a limiting factor in the choice of the wall thickness of the drive bush. Guide surfaces for the clamping jaws may be formed in the channels.

It is very particularly preferred when the first outer circumference and the first inner circumference are designed as polygons, since this allows large torques to be transmitted before shear forces cause deformation of the drive bush. It is preferred for the polygon to be formed by a hexagon, although a different number of edges between 3 and 8 may also be implemented. If a hexagon is selected, providing three channels is sufficient for a typical drill chuck having three clamping jaws; however, if six channels are provided at 60° intervals, incorrect assembly is precluded. The compactness of the design is enhanced when the polygon, in particular the hexagon, is aligned with the guide channels in such a way that the surfaces connecting the edges, rather than the edges, face the clamping jaws.

It is further preferred when, from the axially rearward end of the chuck body, a fitting receptacle can be formed that is graduated axially forward from the spindle holder, with a passage extending from the fitting receptacle to the tool holder. The diameter of the fitting receptacle is preferably 12 mm, since this allows sufficient remaining material thickness of the chuck body in the area with a good remaining thickness of the spindle.

The diameter of the passage can be smaller than the diameter of the fitting receptacle, so that the fitting receptacle can also act as a stop. An internal thread may be formed in the passage. This internal thread is not necessarily or primarily used to interact and axially secure the spindle relative to the chuck body, but, rather, on the one hand allows the spindle to be pushed out of the spindle holder using a forcing screw, which is particularly advantageous when corrosion may occur in the area of the interface between the spindle and the chuck body under adverse climatic conditions. On the other hand, this internal thread can be used for mounting and machining of the drill chuck, since the thread otherwise used for this purpose to secure the spindle is not necessarily present. In particular during grinding operations, considerable additional effort is avoided due to the fact that use of the locking screw and its assembly and disassembly are unnecessary.

If a countersink extending axially forwardly in a graduated manner at the passage can be formed from the tool holder to the passage, the screw head of the locking screw can be inserted there without interfering with the tools or workpieces to be inserted into the tool holder.

The diameter of the internal thread of the passage can be advantageously larger than the diameter of a locking screw that extends through the passage, since engagement of the locking screw with the internal thread does not occur, and interaction of the locking screw with this internal thread is prevented.

The above-mentioned advantages and effects also apply to a drill chuck according to the above-mentioned examples in combination with a drill having a drill spindle, wherein the drill spindle at its end axially facing the drill chuck has an engagement section having a non-circular second outer circumference whose shape corresponds to that of the first outer circumference. The drill spindle advantageously has a spindle pin, pointing axially from the engagement section toward its free end, for guiding in the fitting receptacle, and having a pin diameter that is matched to the fitting receptacle. The axial extension of the drive bush ensures that the engagement section is also able to enter the drive bush.

In addition, a forcing screw having an outer diameter that is matched to the diameter of the internal thread of the passage may be provided, via which the drill spindle of the drill is pressed out of the spindle holder when the forcing screw is screwed into the internal thread.

The design of the drill chuck allows the formation of a combination of a drill chuck of the above-mentioned type with such a drill having a drill spindle, wherein the drill spindle at its end axially facing the drill chuck has an engagement section having a non-circular second outer circumference whose shape corresponds to that of the first outer circumference.

It is preferred when the drill spindle has a spindle pin, pointing axially from the engagement section toward its free end, for guiding in the fitting receptacle, and having a pin diameter that is matched to the fitting receptacle, since this facilitates and enables centering of the spindle relative to the chuck body.

Better fixing of the position of the spindle relative to the chuck body is also achieved when the end face of the engagement section facing axially toward the free end of the drill spindle is designed as a first flat surface. It is advantageous for the axially rearward end of the chuck body to also be designed as a second flat surface that interacts with the first flat surface.

The spindle may be aligned with its spindle pin in the spindle holder via the fitting receptacle, thus simplifying axial securing. The design according to the invention with the drive bush, which brings about torque transmission between the spindle and the chuck body, allows torques greater than 200 Nm to be transmitted. The axial securing of the spindle may be achieved completely independently of the torque transmission by means of a locking screw, in particular in the M6 format, which extends from the tool holder through the passage and to the spindle holder, where it can be screwed into a screw receptacle formed in the spindle, as a result of which an axial pull-down of the spindle onto the chuck body takes place via the first and second flat surfaces.

The features and feature combinations mentioned above in the description as well as the features and feature combinations mentioned below in the description of the figures and/or only shown in the figures may be used not only in the particular stated combination, but also in other combinations or alone without departing from the scope of the invention. Thus, examples not explicitly shown or explained in the figures, but which follow and are producible from the described embodiments via separate feature combinations, are regarded as encompassed and disclosed by the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a longitudinal section through a drill chuck with an attached spindle as part of a drill or machine tool,

FIG. 2 shows a perspective illustration of the drill chuck with the drive bush and the spindle separate,

FIG. 3 shows a perspective illustration of the subject matter of FIG. 1,

FIG. 4 shows a side view of a drill chuck with the spindle, illustrated in a partially sectional view,

FIG. 5 shows an illustration, corresponding to FIG. 4, of the combination of a drill chuck with a grinding or mounting spindle,

FIG. 6 shows an illustration, corresponding to FIG. 4, of the combination of a drill chuck with a forcing screw,

FIG. 7 shows a perspective illustration of an isolated spindle,

FIG. 8 shows a side view of the spindle from FIG. 7 in a partially sectional illustration, and

FIG. 9 shows an illustration, corresponding to FIG. 4, of an isolated drill chuck.

### DETAILED DESCRIPTION

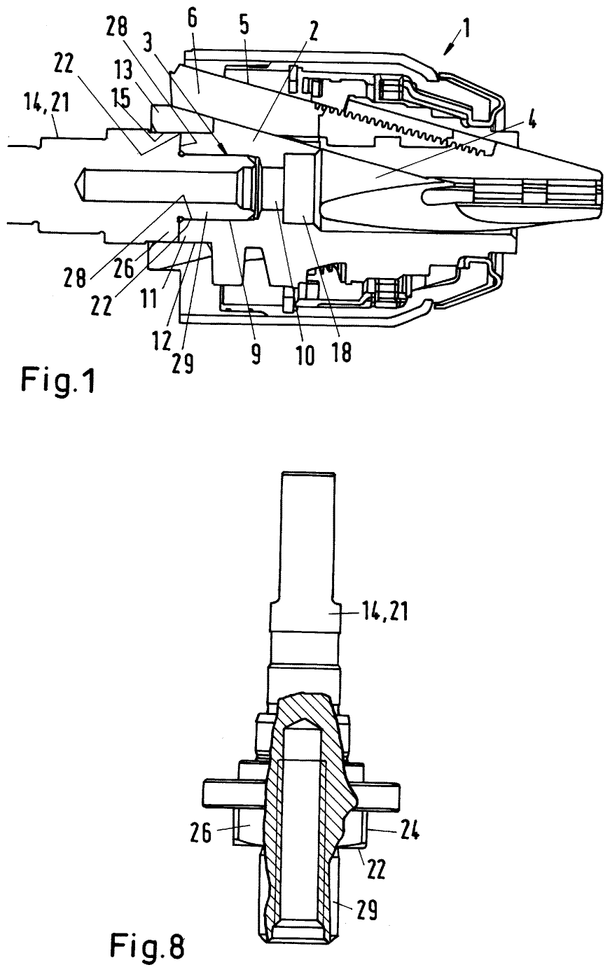

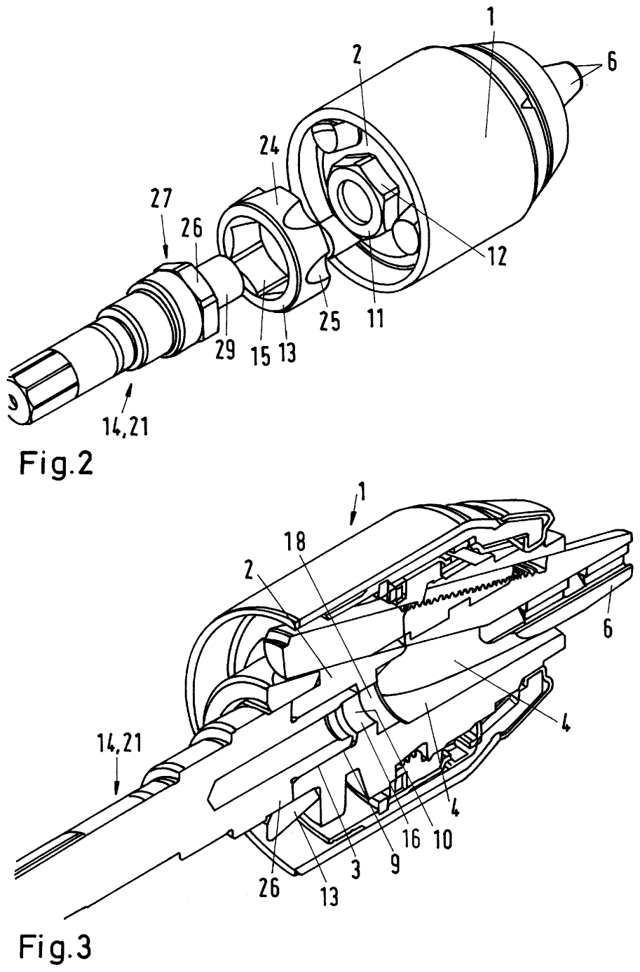

FIG. 1 shows a drill chuck 1 with a chuck body 2, having a spindle holder 3 at its rear end, and a tool holder 4 at its axially front end into which clamping jaws 6, which are displaceably guided in guide channels 5 of the chuck body 2, extend. An annular collar 11 having a non-circular first outer circumference 12 protrudes axially rearwardly from the axially rear end of the chuck body 2. It is particularly apparent from FIG. 2 that a drive bush 13 is present which is mountable on the annular collar 11 and which has a first inner circumference 15 that is adapted to the first outer circumference 12 for torque transmission. The axial extension of the drive bush 13 is greater than that of the annular collar 11.

It is also apparent in FIG. 2 that in a second outer circumference 24 of the drive bush 13, a number of channels 25 for guiding the clamping jaws 6 through are formed which at least correspond to the number of clamping jaws 6, wherein in the examples shown, guide surfaces for the clamping jaws 6 are formed in the channels 25. The number of channels 25 may also be greater than the number of clamping jaws 6, namely, if misorientation with respect to the clamping jaws 6 in the arrangement of the drive bush 13 can thus be avoided.

In the examples, the first outer circumference 12 and the first inner circumference 15 are designed as a polygon, namely, a hexagon. The hexagon is oriented in its rotational position on the chuck body 2 in such a way that three of its wrench flats face the clamping jaws 6. In this example, a channel 25 may also be formed on each wrench flat to avoid misorientation.

FIGS. 1 and 3 show that from the axially rearward end of the chuck body 2, a fitting receptacle 9 is formed that is graduated axially forward from the spindle holder, with a passage 10 extending from the fitting receptacle 9 to the tool holder 4. The diameter of the fitting receptacle 9 is 12 mm, for example. It is also apparent from these figures that the diameter of the passage 10 is smaller than the diameter of the fitting receptacle 9.

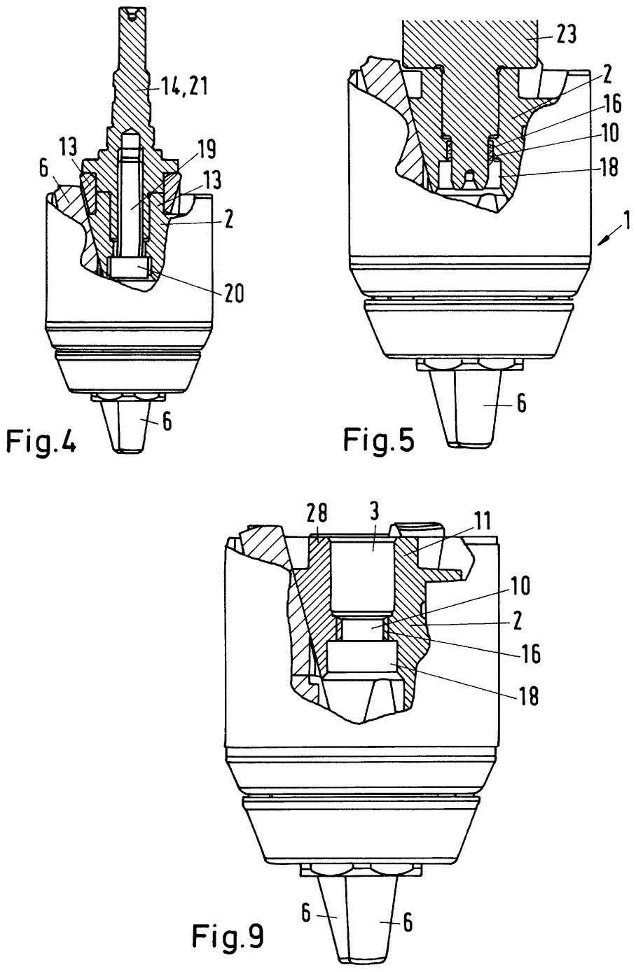

An internal thread 16 is formed in the passage 10. The example in FIG. 5 shows its use in conjunction with a grinding spindle 23 or a mounting spindle, which can be used for manufacturing the drill chuck 1 and whose assembly is greatly simplified by the internal thread 16.

Extending axially forward in a graduated manner from the passage 10 is a countersink 18 which is formed from the tool holder 4 to the passage 10, and into which a screw head 20 of a locking screw 19 can immerge. The diameter of the internal thread of the passage 10 is larger than the diameter of the locking screw 19 that extends through the passage.

The drill chuck 1 described above may be combined with a drill having a drill spindle 21, wherein at its end axially facing the drill chuck 1, the drill spindle 21 has an engagement section 26 having a non-circular second outer circumference 27 whose shape corresponds to that of the first outer circumference 12. This engagement section 26 can engage with the drive bush 13 during assembly, for which purpose the shape of the engagement section 26 is adapted to the shape of the annular collar. The axial extension of the drive bush 13 is also selected in such a way that the engagement section 26 and also the annular collar 11 can engage with the drive bush 26, thus establishing a torque-transmitting connection between the spindle 14 and the chuck body 2 that is highly resilient. The end face of the engagement section 26 facing axially toward the free end of the drill spindle 21 is designed as a first flat surface 22, and is intended and suited for interaction with a second flat surface 28 at the axially rearward end of the chuck body 2. A spindle pin 29 is used for centering in the fitting receptacle 9.

FIG. 4 shows how the spindle holder 3 is used to connect to a spindle 14, which is illustrated in isolation but which can be designed as a drill spindle 21, as part of a drill, or as a grinding spindle 23. The locking screw 19 is used to axially secure the spindle 14 in the spindle holder 3; its screw head 20 engages with and is arranged in the countersink 18. The locking screw 19 pulls the first flat surface 22 of the spindle 14 against the second flat surface 28 of the chuck body 2, thus specifying the axial position. The radial position of the spindle 14 is specified by the fitting receptacle 9, which is also used for centering. FIG. 5 shows the option that for fairly low stresses, such as when a grinding spindle 23 is placed in the spindle holder 3, the passage 10 with its internal thread 16 may also be used to secure the grinding spindle 23, so that a locking screw 19 does not have to be mounted and dismounted.

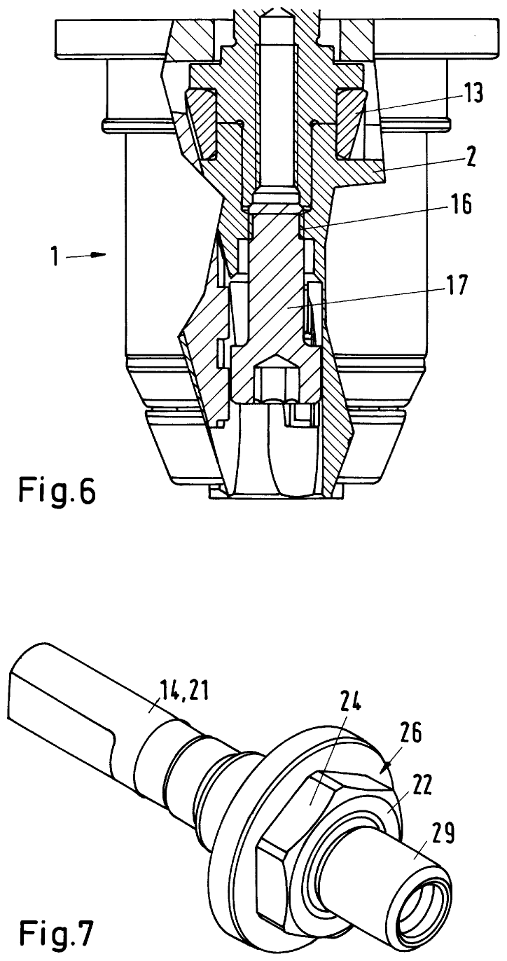

Access to the passage 10 with the internal thread 16 is opened up after the locking screw 19 is removed. The drill spindle 21 or grinding spindle 23 may be pressed axially out of the spindle holder 3 by use of a forcing screw 17 that is screwed into the internal thread 16 (FIG. 6).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drill chuck comprising:
a chuck body having a spindle holder at its rear end;
a tool holder arranged at an axially front end of the chuck body;
clamping jaws that extend towards the tool holder, the clamping jaws being displaceably guided in guide channels in the chuck body;
an annular collar having a non-circular first outer circumference protrudes axially rearwardly from the axially rear end of the chuck body; and
a drive bush having a first inner circumference that is adapted to the first outer circumference for torque transmission, the drive bush being mountable on the annular collar,
wherein an axial extension of the drive bush is greater than that of the annular.

2. The drill chuck according to claim 1, wherein, in a second outer circumference of the drive bush, channels for guiding the clamping jaws are provided in a number corresponding at least to the number of clamping jaws.

3. The drill chuck according to claim 1, wherein the first outer circumference and the first inner circumference are designed as polygons.

4. The drill chuck according to claim 4, wherein the polygon is formed by a hexagon.

5. The drill chuck according to claim 1, wherein, from the axially rearward end of the chuck body, a fitting receptacle is formed that is graduated axially forward from the spindle holder, and wherein a passage extends from the fitting receptacle to the tool holder.

6. The drill chuck according to claim 5, wherein the diameter of the passage is smaller than the diameter of the fitting receptacle.

7. The drill chuck according to claim 5, wherein an internal thread is formed in the passage.

8. The drill chuck according to claim 5, wherein a countersink that extends from the passage axially forwardly in a graduated manner is formed from the tool holder to the passage (10).

9. The drill chuck according to claim 5, wherein the diameter of the internal thread of the passage is larger than the diameter of a locking screw that extends through the passage.

10. The drill chuck according to claim 1, wherein, in combination with a drill having a drill spindle, the drill spindle at its end axially facing the drill chuck has an engagement section having a non-circular second outer circumference whose shape corresponds to that of the first outer circumference.

11. The drill chuck according to claim 10, wherein the drill spindle has a spindle pin pointing axially from the engagement section toward its free end, for guiding in the fitting receptacle, and having a pin diameter that is matched to the fitting receptacle.

12. The drill chuck according to claim 5, wherein a forcing screw is provided which has an outer diameter that is matched to the diameter of the internal thread of the passage.

13. A drill comprising a drill spindle, wherein the drill spindle at its end axially facing the drill chuck has an engagement section having a non-circular second outer circumference whose shape corresponds to that of the first outer circumference.

14. The drill according to claim 13, wherein the drill spindle has a spindle pin pointing axially from the engagement section toward its free end, for guiding in the fitting receptacle, and having a pin diameter that is matched to the fitting receptacle.

15. The drill according to claim 13, wherein the end face of the engagement section pointing axially toward the free end of the drill spindle is designed as a first flat surface.
